(19) United States
(12) Patent Application Publication
(10) Pub. No.: US 2014/0278855 A1
(43) Pub. Date: Sep. 18, 2014

(54) DYNAMIC INCENTIVES

(71) Applicant: LIST TECHNOLOGIES, INC., San Francisco, CA (US)

(72) Inventors: Marshall Taylor CLARK, San Francisco, CA (US); Daniel METRIKIN, San Francisco, CA (US)

(73) Assignee: LIST TECHNOLOGIES, INC., San Francisco, CA (US)

(21) Appl. No.: 13/843,296

(22) Filed: Mar. 15, 2013

(51) Int. Cl. G06Q 30/02

(52) U.S. Cl. CPC G06Q 30/0211
USPC 705/14.13; 705/14.35

(57) ABSTRACT

A system and method for providing dynamic incentives is described. An individual incentive may include a message portion, offer value portion, creative, and an audience segment. A mix of incentives is distributed and the mix is optimized based on delivery data and redemption data. Other applications include determining an audience segment and optimizing incentive design for other campaigns.

### FIELD OF THE INVENTION

The present invention is generally related to providing dynamic incentives.

### BACKGROUND OF THE INVENTION

Coupons provide an incentive for a consumer to buy a product. As illustrated in FIG. 1, conventionally, coupons are distributed with a static face value for the duration of a campaign. Typically, a fixed total number of coupons are distributed during the campaign. That is, in a print campaign, a certain number of newspaper inserts may be distributed during the length of the campaign. Average redemption rates from past campaigns are often used to predict costs. For example, suppose a static $2 off coupon is distributed in a Sunday metro newspaper for a total of 500,000 coupons. Typical redemption rates are 1% to 7%. If average redemption rates in past campaigns are 5%, then it would be anticipated that $25,000 coupons will likely be redeemed.

Currently, most coupons are served through newspapers, through a freestanding insert (FSI). These are the paper coupons seen in newspapers and typically, they're clipped out and redeemed in the store. The best targeting available with newspapers is typically on a geographical location based on postal code (in the United States postal code system—at a zip plus four level), so very little targeting is available.

As an illustrative example, a coupon in a newspaper may offer $2 off on diapers purchased before an expiration date. The consumer then clips the coupon and takes it to a store. The store gives the consumer the discount at the point of sale and then the store sends the coupon for processing at a redemption center. Many redemption centers are located in regions with low labor costs. For example, there are coupon redemption centers in Mexico that process coupons from stores in the United States. Thus, in the example of a coupon for $2 off on diapers, a consumer buys the diapers at a store, and then, the store boxes up coupons and sends them to the redemption center in Mexico. The redemption center then counts the redeemed coupons, and this accounting is used to determine the compensation provided back to individual store chains. The time lag between when a coupon is redeemed, and when a redemption center accounts for the redeemed coupon, can be on the order of weeks to a month or more.

Digital coupons are available from companies such as coupons.com. These coupon systems essentially function as ad networks. They have a captive audience that comes to the site and the company of the network will host a bunch of coupons from manufacturers on the site. These are static coupons; they have a static value for all users. There's also usually very little targeting available, if any at all. This is because the nature of the business model is that they tend to want to sell all of their inventory and will not allow advertisers to segment that inventory based on audience-based characteristics such as demographic, household income or behavior.

The coupon industry has been slow to adopt new technologies. There are web-based versions of coupons in which the coupon is distributed via the Internet, such as by having the consumer print out a hard copy of the coupon. However, conventional commercial web-based coupons use a similar model as print coupons. A campaign has a fixed duration and a static coupon with a fixed value is distributed.

Therefore, what is desired are improved ways to provide incentives.

### SUMMARY OF THE INVENTION

A method, system, and computer program product is provided for providing dynamic incentives, where the incentives are redeemable at a time subsequent to delivery. In one embodiment an incentive platform is responsible for targeting, pricing, construction, distribution, tracking, and optimizing a mix of incentives. An individual incentive unit may be distributed by an ad network and include messaging, an offer value, a creative, and be directed to an audience segment. The delivery and later redemption of an incentive may be tracked.

One embodiment of a method includes generating incentive options for a marketing campaign of a particular product or service. The incentive options for an incentive unit include message options, offer value options, creative options, and audience segment options. A mix of incentives is distributed via digital communication channels wherein an individual incentive has a unique combination of message option, offer value option, creative option, and audience segment. An individual incentive is redeemable by an end user after delivery within a time period defined by the marketing campaign. An example of a digital communication channel is an Internet communication channel. The delivery and redemption of the incentive may be tracked via unique identification codes. The mix of incentives is optimized during a marketing campaign.

### BRIEF DESCRIPTION OF THE DRAWINGS

FIG. 1 is a flowchart illustrating a prior art method of distributing coupons with a static value.

FIG. 2A illustrates providing message, offer, creative, and audience options to form unique combinations for dynamic incentives in accordance with an embodiment of the present invention.

FIG. 2B illustrates a template for an incentive in accordance with an embodiment of the present invention.

FIG. 3 illustrates an example of incentives having unique combinations of message, offer, creative, and audience selections in accordance with an embodiment of the present invention.

FIG. 4 is a flow chart illustrating a method of providing dynamic incentives in accordance with an embodiment of the present invention.

FIG. 5 illustrates a method of identifying audience segments.

FIG. 6 illustrates a method of identifying information for another marketing campaign.

FIG. 7 illustrates a dynamic incentive system in accordance with an embodiment of the present invention.

FIG. 8 illustrates in greater detail an embodiment of selected modules of FIG. 7 for creating, distributing, tracking, and optimizing dynamic incentives.

FIG. 9 illustrates a management and reporting user interface showing a listing of marketing campaigns in accordance with one embodiment of the present invention.

FIG. 10 illustrates a management and reporting campaign for managing an individual campaign in accordance with one embodiment of the present invention.

FIG. 11 illustrates a set of all of the MOCA line items for a campaign, where each unique MOCA line item is selectable to obtained detailed information in accordance with one embodiment of the present invention.

FIGS. 12 and 13 illustrate line item management data for two different MOCA combinations in accordance with one embodiment of the present invention.

FIG. 14 illustrates an example of how redemption rates may vary for different MOCA incentive values and audiences in accordance with one embodiment of the present invention.

### DETAILED DESCRIPTION

The present invention is generally directed to dynamic incentives. An incentive is a promotional tool incorporating a transferable unit that can be saved by, or attributed to a given user for redemption at a later time of purchase, in exchange for a monetary discount or other valued award.

The transferrable unit of the incentive may be represented in the form of a coupon that is printed out and redeemed. Additionally, the transferrable unit could be a softcopy version of a copy. However, more generally, the transferrable unit could provide a redemption code. In one implementation, the transferrable unit may be a print at home coupon in which an ad unit would allow a user to print out a coupon on their home printer and take the printed coupon to a retailer location where they could redeem it using the existing systems. In another implementation, the transferrable unit may be implemented as a direct to loyalty card coupon, such as a store loyalty card. The user at this point would scan their loyalty card at the point of sale and the coupon would be deducted from the purchase total.

In one embodiment, there are three forms of feedback. First is feedback associated with impression data confirming that an incentive was served. For example, the impression data may correspond to an impression instance when an ad unit containing the incentive is served on a web page. Second, there is feedback associated with delivery data, where delivery data is generated in response to consumer accepting the incentive, such as the consumer clicking on the served incentive to print a coupon, or adding the incentive to a loyalty card. Third, feedback comes from the retailer that shows that the coupon in question was actually redeemed. Not everyone that accepts delivery of an incentive will redeem it before the expiration date. Thus, the three types of feedback, impression data, delivery data, and redemption data will normally be different. Additionally, in many cases the redemption data will occur with a significant time lag relative to the delivery data. For example, if a coupon is printed as a hardcopy coupon by a consumer, it may be some days or weeks before they redeem the coupon at a store. Additionally, there is a processing time for the store to ship coupons to a clearinghouse and for the clearinghouse to issue a report.

FIG. 2A illustrates how in one embodiment, at some initial time in a marketing campaign, a set of options are defined for an incentive. These options include Message Options, Offer Options, and Creative Options. Audience segment options may be defined in one option. These options permit many different unique combinations to be formed and served in an incentive mix.

FIG. 2B illustrates a template design. Creatives, message text, product information, and incentive portions may be included. In this example, a hero image provides a placeholder for a creative. Portions of the template provide placeholders for portions of the text of the message options. The coupon portion in this example shows the offer value and may also be clickable for a user to receive delivery of the incentive. It will be understood that other types of template designs and formats may also be utilized.

In the Message-Offer-Creative-Audience (MOCA) model, the offer or incentive value is defined as the monetary discount or other value award provided in exchange for redemption of the transferrable unit. In one embodiment, a dynamic incentive has: 1) an incentive value (an offer value, O); 2) a creative format (C); and 3) text message (M) content that is selected from a plurality of predetermined parameters at the time the dynamic incentive is served to a given user. A dynamic incentive may be directed to an audience (A) segment. The incentive value is defined as the monetary discount or other value award provided in exchange for redemption of the transferrable unit. The creative format is defined as all visual properties ascribed to the promotional tool and associated transferrable unit, including, but not limited to shape, size, color, layout, audio, visual and images. The message text content is defined as all textual information contained in the promotional tool and associated transferrable unit, including, but not limited to, product names, company names, product names, promotional language, expiration dates, incentive limitations, and any redemption terms and conditions.

Note the MOC portions of the incentive may vary based on factors such as the audience segment, inventory available for the product, and date an incentive is served. For example, offer value ranges may be different for different audiences that are likely to have a higher value. Examples of factors that might be considered in determining whether a different offer value range should be applied to an audience segment include standard demographic data, a user's previous online behavior, a user's exposure to product specific digital assets, a user's activity on or to product-specific digital assets, a user's purchase history, a user's social graph history, and a user's geographic location. The date an incentive is served and inventory data for the product may also be used as a factor to vary the range of offer values during a campaign. Similarly, the creative format and text content may also be adjusted based on similar factors. For example, if a user has previous online behavior or exposure to a particular company's diapers then the message and creative portions may be adjusted to take into account the previous exposure. Creatives and message may also be adjusted to account for regional geographic difference (e.g., different hero picture creatives in different geographic areas).

FIG. 3 illustrates a MOCA example for a wine product. The incentive may be based on a basic template design with spaces for message text, offer value, and creatives, in which the incentive also is assigned an audience segment. In this example, at some initial time a variety of different message options are created, ranges of offer values defined, a set of creatives provided. This forms a set of MOCA parameters. Audience segments are also assigned. A matrix of unique MOCA combinations is supported for an individual product of a marketing campaign. In the most general case, many dozens or even hundreds of MOCA combinations may be supported.

Each incentive distributed is given a unique ID for tracking purposes, where the unique ID identifies the unique combination of MOCA parameters used in the incentive, ID information to identify the product, ID information to identify distribution information. Feedback data is used to dynamically optimize the mix.

As will be described later in more detail, a marketing campaign may take into account all of the costs to distribute a transferable unit in addition to the redemption costs. Additionally, the distribution costs may vary depending on the audience. Providing a range of MOCA combinations for different audiences permits an incentive campaign to be optimized in ways not previously possible.

Referring to FIG. 4, in one embodiment, campaign goals are defined in block 405 as well as the range of MOCA parameters. An initial incentive mix is selected in block 410. The incentives are distributed in block 415 where each transferrable unit includes a unique ID defining the MOCA combination. Additionally, at the time of distribution, additional distribution data can be embedded. For example, in the case of a web coupon, there are different costs associated with distributing the web coupon, including the server cost, assignment cost, and processing cost associated with gathering information from third party services to identify an individual within a desired audience segment, and then, serve the web coupon when an individual in the desired audience is viewing a web page. These costs are variable and may depend, for example, on how narrow an audience segment is defined (since this may require more expensive third party information to find and serve ads), and the costs associated with serving the web coupon in a given distribution channel. The delivery data is tracked 420. The redemption data is also tracked 425 based on the unique ID. The incentive mix is dynamically adjusted during the campaign for best performance in block 430. The optimization is based on at least the delivery data and the costs. If redemption data is available, the redemption data may be used for the optimization. The redemption data, as it become available, may also be used to adjust a statistical model between the relationship of delivery data and redemption data. In some campaigns, for example, the time lag between when delivery data is available and when redemption data is available can be substantial. Redemption data can be delayed by weeks or even months.

There are other applications, such as performing various tests and calibrations for a campaign or a related campaign. This includes, for example, identifying relationships between incentive value and receiving audiences, relationships between content format and receiving audiences, relationships between text content and receiving audiences, and identifying audiences.

Referring to FIG. 5, in one embodiment campaign goals are defined in block 505. An initial incentive is selected 510 with fixed parameters, such as a fixed creative, offer, and message. The incentive is distributed 515. The incentive delivery is tracked 520 and redemption data is tracked 525. Third party data sources are accessed to identify audience segments within the general audience of those individuals that received delivery and/or redeemed the incentive.

Referring to FIG. 6, another application is to generation information for another campaign. In particular, the effectiveness of message, offer, and creative options may be tested for an audience. A set of MOCA parameters is defined in block 605. The incentives are distributed 610 and tracked 615 and 620. The optimum MOCA parameters are identified for another campaign, such as a print campaign or another online campaign.

FIG. 7 illustrates an exemplary system in accordance with an embodiment of the present invention. A dynamic incentive platform 700 is implemented as computer software modules stored in a non-transitory computer readable medium and executable by one or more processors. In one implementation, the dynamic incentive platform includes a data store (not shown), a non-transitory memory for storing computer code, processors, and servers. An exemplary implementation is as a server-based system having a web-based user interface 705 for a marketer to define and monitor an incentive campaign via a web portal, interfaces to third party data providers, interfaces to distribute the transferrable unit to the web (e.g., as an ad unit via ad exchanges and advertising networks online), and interfaces to receive feedback in the form of impressions instances, delivery instances, and also redemption data from a redemption service, where the redemption data includes a unique tracking ID.

In one embodiment, the dynamic incentive platform module 700 includes an incentive create module 750, an incentive distribute module 760, an incentive track module 770, and an incentive optimize module 780.

FIG. 8 illustrates an embodiment of the incentive create module 750 which includes a campaign builder 752 that sets campaign parameters such as total budget, the campaign duration, flight dates, expiration dates, terms & conditions, approved redeemer(s) (locations, sites, etc.), campaign goals, max redemption, max value, audience prospect, audience conquest, rate of serving, frequency caps, billing information (I/Os), redemption clearance provider(s), and other media servers used (for attribution purposes). The campaign builder is also used to define media assets, including the creatives and the messaging (copy/text/audio/video).

The segment builder 754 defines custom audience segments, where each segment receives a unique ID. Examples of information used to define an audience segment include combinations of factors such as: third party segments, demographics, behavior, purchase history, first party data (e.g., from the manufacturer), existing shopper information, loyalty information, retargeting data (site exposure/actions), media data (media exposure/actions), lifetime value, redemption value ($), and purchase history.

The segment builder may leverage off of existing third party data sources and services developed for online advertising. Examples of companies providing data for identifying audiences include Turn of Redwood City, Calif., Data Zoo, and Google's Double Click Digital Marketing (DDM).

The price builder 756 permits a range of price values to be defined with flexible increments. For example, a range may be $1 to $5 in increments of 50 cents. In one embodiment, target ranges are defined per audience segment as defined in audience targeting. That is, the target ranges do not have to be the same per audience segment.

The price ranges do not have to be fixed during a campaign. As one example, a decay function may be included to decrease the range based on various factors, such as dates. For example, the decay function may decrease the range the longer a person waits to redeem a coupon, or the decay may be during the campaign. The price ranges may also vary over time with linear or step functions. Alternatively, the price ranges may vary depending on inventory inputs from a manufacturer/distributor to permit the offer value to vary based on known inventory levels.

The asset builder 758 builds the individual MOCA portions of the transmittable units of an incentive. Templates are defined by serving size corresponding to an ad size. Multiple variables are combined to create an incentive, including the creatives, messaging (copy/text/audio/video), and other variables such as terms and conditions and expiration date. The offer value is based on the price builder's selections. A unique ID (UID) is generated based on all of the relevant variables of an asset. In one embodiment, all of the different permutations are assembled ahead of time and stored. Alternatively, the assets can be assembled on the fly using rules.

FIG. 8 also illustrates an embodiment of an incentive distribution module 760, which provides distribution options. A channel selector 762 provides the option to select media distribution channels for the incentives, such as display, video, search, mobile, wallet, social media, apps, and email.

A distribution element 764 provides the option to select distribution partners. Examples include ad exchanges and ad networks.

A publishers element 766 provides the option to select publishers. Examples include selecting from a white list (of acceptable publishers) and a black list (of unacceptable publishers). For example, the white list may be a list of acceptable publishers according to a set of criteria or guidelines defined by a marketer or a manufacturer of the product.

An additional unique distribution ID is also added to an incentive to track how an incentive was distributed. The unique distribution ID may, for example, be based on a combination of channels, partners, and publishers above.

FIG. 8 also illustrates an exemplary tracking module 770. The pre-serving tracking 772 includes tracking the pre-serving codes. In one embodiment, the pre-serving codes include an audience segment ID (as defined by the segment builder), product inventory (as measured by marketer-provided data input), a creative ID, a message ID, and an offer value ID.

The post-serving tracking 774 tracks serve-time codes. These may include the publisher (that served the incentive) and the assignment channel/vehicle (e.g., Paypall Mobile Wallet). The serve cost is also tracked. Geo location may also be tracked (e.g., approximate geographic location where the incentive was served). A code system module 776 supports code management.

The post serve time tracking also includes tracking available redemption attributes, such as redemption time, date, and location.

The Incentive Data Management Platform (DMP) 778 includes a database that stores all trafficking details per campaign. In one embodiment, the DMP generates all of the unique IDs as a global ID. Additionally, the DMP receives and stores publisher assignments and redemption data. In one implementation, the DMP appends the publisher assignment data and redemption data to the unique global IDs. In another instance each Global ID is assigned to a MOCA value, allowing the Incentive DMP to perform segmentation by audience, message, creative, offer, along with any other parameters assigned to the Global ID

FIG. 8 also shows the optimize module 780 in accordance with one embodiment of the present invention. A performance monitor 782 monitors performance to determine a return on investment. This includes looking at all of the different costs for an incentive, which includes not only the redemption cost but other costs (e.g., server cost, assignment cost, and any other processing costs). An exemplary list of costs includes serving costs, media costs, data costs, and assignment costs (if using an outside system, such as print at home fees, loyalty card fees, etc.), redemption costs, and clearance costs.

The performance may be calculated using different metrics. Examples include:

CPD—cost per delivery (average cost per incentive print-out or direct-to-card save—including but not limited to media costs, data costs, ad serving costs, incentive print/save rate, and projected costs associated with the offer values delivered);

CPR—cost per redemption (average cost to clear incentive—including but not limited to all factors in CPD, redemption/clearing-house fees, transaction fees, and incentive redemption rate)

CPUM—(average total cost per unit moved—including but not limited to all factors in CPD, CPR, and projected costs associated with the offer values delivered, and the actual face value of incentives redeemed)

In one embodiment, functions to calculate total cost to move an item based on these variables may include:

eLTV—a method to calculate estimated life-time-value for a redemption against a given MOCA or mix;

The return on investment (ROI) may be calculated as ROI: ((cost per unit moved)−(revenue))/(cost per unit moved) against a given MOCA or mix;

A programmatically optimized Budget Mix element 784 dynamically adjusts a budget mix. It assigns a value to the different incentive permutations of audience, pricing, messaging, distribution, publishers, redemption channels, assignment channels, etc. The optimized budget mix element 784 may start with an even or pre-defined mix. The mix is then optimized based on the campaign goals and calculated performance.

In one implementation, the mix is adjusted for each possible combination of incentives to drive towards campaign goals. This may include, for example, disabling poor performing combinations.

In this stage of the process, the system takes all these data inputs and optimizes and basically iterates to determine an optimum mix of inventory sources to use, e.g., the ad units that are distributed favor the mix that will best achieve the campaign goal. The mix is adjusted to favor the most profitable or highest performance audiences with the respective highest performing combination of creative, message and offer value for that particular audience. The process continues to iterate, while the campaign is running until the campaign is complete.

In one embodiment, the incentive mix may be adjusted to account for the impact of the incentive campaign on other marketing efforts. In one implementation, a media attribution system (not shown) measures attitudinal lift from audiences exposed to an incentive versus audience that were not exposed As an example, a incentive mix may be a value-add to other marketing efforts. For example, it may generate lift to purchase intent.

In another embodiment, the external marketing mix may be adjusted to account for impact on incentive campaign performance. In one implementation, an incentive attribution system (not shown), measures incentive campaign performance across external marketing mix parameters. As an example, a given marketing mix may boost downstream incentive campaign performance.

In one embodiment, predictive modeling is used to make adjustments to the budget mix to adjust the expiration dates and other parameter to control liability. In particular, there is a time delay between when an incentive is distributed, when it is redeemed, and also possible variability in redemption rates over time.

Marketer analytics may be included to measure campaign performance against goals. Marketer analytics may also be used to monitor the campaign budget, make manual adjustment of the budget mix in-flight (by the marketer), and measure performance of each variable (e.g., offer value, messaging, and creative per segment). Marketer analytics may also be used to expose audience insight data valuable to marketing and product development. As an example, data to identify the ideal creative, messaging, and offer combinations for a given audience.

As previously discussed, a user interface 705 may be provided to define and monitor an incentive campaign. FIG. 9 illustrates an example of management and reporting user interface. In this example, a high-level over page provides listing of all current marketing campaigns for a marketer. The marketer (or whoever is managing the campaign) may select an individual campaign to drill down into more detailed information. FIG. 10 illustrates in the left-hand panel a listing of the advertiser, campaign flight dates, audiences, budgets, offers, creatives, messaging, delivery details, and codes. A listing of line items may also be provided. A summary of details is provided, which is this example includes the media budget, flight dates, incentive budget, media daily limits, offer range, offer increment, delivery codes, creatives, messaging, delivery system, and audience. FIGS. 12 and 13 illustrates management information displayed for two different MOCA combinations. In these examples, data on how an individual MOCA is performing over time is also displayed, such as historical data on spending parameters, impressions, deliveries, and cost per delivery (CPD).

FIG. 13 illustrates a hypothetical example of how redemption rates may vary with incentive value for constant set of message and creative options M1C1 for three different audiences A1, A2, and A3. Redemption rates may vary with audience and are also likely to flatten out with increasing incentive value. Additional curves could be generated for other messaging and creative options, as indicated by the dashed lines for other message and creative options (M2C2A1 and M3C3A1). More generally, other attributes, such as delivery rate, could also be plotted as a set of curves.

One aspect of FIG. 13 is that the system collects data for many different MOCA combinations and can perform multivariate testing and programmatic optimization. The system performance of each unique MOCA combination can be calculated, particularly the calculated cost per unit moved for each unique MOCA combination. The system then re-allocates the budget mix accordingly to optimize value for a marketing campaign.

### USE EXAMPLES

### Example 1

Suppose a marketer decides they want to do a coupon campaign for a product. They define a range of variables for the offer values that are for that coupon. Let's say the range is $1.00 to $3.00. They define what their ideal target audiences are, who they want to target for that specific product, and then, based on that, they have different combinations of creatives they use. This could be a different image on the coupon, a different messaging, a different wording, and what the ad unit looks like.

All that information is fed into the dynamic incentive system 500, and the system then defines all of the different unique combinations of coupons based on those parameters. Even with a relatively small number of options for each MOCA variable, the system ends up with many possible combinations for the initial mix, which in some cases may be on the order of hundreds or even thousands of possible combinations.

As an illustrative example, consider a simple example in which there are four audience segments, four face values of the offer, four creatives, and four message options. There would be 4×4×4×4 unique combinations for a total of 256 unique combinations of transmittable units pushed out into the market.

These units are then distributed out through various digital media sources as ad units to the web, such as through ad exchanges, RTB inventory sources, and network sources. As the targeted audiences view the ad unit, they are able to click on the unit which in turn allows them to reveal a component to receive delivery of the transmissible unit of the dynamic incentive. For example, in one instance a coupon offer appears on a digital media source (e.g., a webpage of a website, etc.), and when the user clicks on the offer they are presented with the options to print out a hardcopy on their home printer or receive a download into a loyalty card by, for example, the user entering a loyalty card number (direct to card coupon). When the user then visits the store, the coupon would be automatically deducted from their total at the point of sale and at checkout.

In either case, when the user prints out a hardcopy or enters a loyalty card number, the system receives feedback that this delivery event has occurred. At the point of sale redemption, the actual value of the coupon is deducted from their shopping total. At this point, the system receives a second data pass indicating that the actual redemption of the delivered coupon occurred.

So based on the two types of feedback data and calculations of different cost factors, the system in this example then optimizes the mix of the 256 different combinations in the portfolio to give the best result for the end client.

Suppose, as an example, that an objective is to target new moms with nine different combinations of creative and face value. The system might find that maybe combination number three delivers much higher results than all the other combinations for that particular audience of new moms. The system would then adjust the budget spending to push more money towards that most effective combination and reduce spending on all the other combinations. When using this iterative process, the system will optimize performance for the entire campaign as a portfolio over time and deliver best results for the advertiser.

The optimization process can be run on a periodic basis (e.g., daily, weekly, or some other basis). As one example, assume that the optimization process is performed regularly on a weekly basis. In one instance, the system would optimize based on delivery of the coupon unit. So it would be optimizing based on when the coupons are actually printed at home or added to the loyalty card. The benefit of this method is that it allows the system to optimize in essentially real time without having to actually wait for the coupon to be redeemed and get the data back.

Data on when coupons are printed or added to a loyalty occur effectively in real time, but redemption data often has a long time lag, where the time lag may depend on whether the incentive is hard copy coupon going to a clearinghouse for processing, or a loyalty card.

In a redemption process, the clearance house process generally tends to take up to six to eight weeks for the retailer to send in those coupons to a clearinghouse, and for the redemption data to be returned. That redemption data would then be used to refine the delivery to a redemption rate model in order to more closely minor real world results.

Statistical approximations, from previous campaigns (or related campaigns), can be used to estimate the correlation. However, as the redemption data becomes available, a statistical model can be built and adjusted.

In one instance of doing optimization based on delivery, a statistical model is built that models the redemption rate, the average redemption rate arising from both delivery of both a printed home coupon and a separate model for the average redemption rate that comes from delivery of a direct card action.

Note that the campaign budget is spent on buying the media to show the coupons, buying the data to identify the target audiences, and then, the actual placement of that coupon via a channel. All of these costs are accounted for, including the redemption costs.

Consider again the example in which there are 256 different combinations. Suppose optimization is performed on a weekly basis. Suppose that two of the instances did not generate any delivery of coupons at all. In this instance, the system might remove these instances directly from the campaign and reallocate budget to the remaining 254 instances. As another example, since the audience is also considered in optimization, one of the four audiences may be underperforming. In this example, the mix may be optimized to allocate less of the budget to the underperforming audience segment.

In another example, the system may see that the $2.00 off face value is performing much better than a $1.00, $1.50 or a $2.50 off value. In this instance, the system may adjust spending to allocate more to spend the $2.00 off value and spend less on the other offer values.

In this example, the optimization process is performed weekly, based on the feedback data available and also taking into account all of the different costs, of which the offer value is only one of the costs. Additionally, note that the value to the marketer may be achieved with a dynamic mix of incentive combinations.

As an example of a coding system, consider a notation system with a multi-digit code. Portions of the multi-digit code may represent separation portions of a MOCA combination. The first part of the code is A plus the number that indicates the audience. So, A indicates audience, one indicates the first audience segment, two is the second, and three is the third, and so on. A second part of the code is C and a number. Let's say C defines creative and number one is the first creative unit, two is the second creative unit, three is the third creative unit. A third part of the code, defines the offer value so O1 would be the first offer value, O2 would be the second offer value, O3 would be the third offer value, and O4 would be the fourth offer value, etc. A fourth part of the code represents messaging options. Let's say M defines messaging and number one is the first messaging unit, two is the second messaging unit, three is the third messaging unit, etc. The code can be code to include a portion to identify distribution information and the product. The code may, for example, be embedded into a bar code (for a printed coupon).

In one implementation, the campaign may start with an even budgetary mix. Thus, each of the 256 combinations receives an even share of the budget to start with.

In this instance, suppose the campaign is initially being managed based on delivery data and some average value of redemption rates from previous work. Digital pixels may be embedded in the distributed ad unit. There could be one pixel for the print at home option and another pixel for the direct to card option. Each time a user clicks on one of these options and receives delivery of a coupon either to a printed home or to a directed card pathway, the system receives a bit of data back that this occurred.

The optimization platform then looks at the delivery data and calculates what is called a cost per delivery. This takes the dollar value associated with the offer itself (face value), & also adds in the media cost associated with pushing the unit out there. So this media cost would include both the—typically cost per M (thousand), a CPM value for what the media costs per purchase, plus usually a data cost. This is also usually expressed in CPM and is the actual cost to purchase the data used to target the audience. All these values are summed and totaled to give the total cost to serve that MOCA, and then, it is divided by the number deliveries. In this case, if a given MOCA required $1000 media costs, data costs, delivery fees, and projected offer costs to deliver 1000 incentives, that would be a CPD of $1.00.

In one embodiment, optimizing based on CPD the campaign is run for a week, looking at all the different 256 MOCA instances and the CPD values can be determined for each one of those instances, each one of those multi-digit codes. The system will then allow for optimization based on these CPD. Units and instances with the lowest CPD are the most desirable since they are most efficient at driving delivery

The optimization process can be continued on the basis of delivery data until redemption data becomes available. The statistical model can be adjusted, as more redemption data becomes available, in order to fine tune the optimization process. In one implementation, predictive modeling is used.

Initially, the system starts actually collecting real time performance data for each unique coupon instance that is delivered. As the campaign goes on, the system optimizes the number of variables for each unique coupon instance based on the goal of the campaign.

Suppose that the campaign is ten weeks long and we predefine which point we want to optimize or the system is optimizing in real time. The system can look at each unique coupon instance, the historic performance of that unique coupon instance, its current performance, and then forecast performance of that unique coupon instance.

In our example, suppose that there are 256 instances. The system looks at their historic performance, current performance and forecasts that performance. Now, based on that, the system started with a certain budget mix allocated to each instance. Based on the goal of the campaign, the system could automatically alter the allocation of the budget in the mix per unique coupon instance based on its performance.

In this example, the system continues to monitor the campaign and optimizes while the campaign is in market per defined time period. So, assume we define the campaign to run for 10 weeks, and the intervals in which optimization engine monitors the performance. For example, on a weekly basis. Over the course of 10 weeks, the system would then programmatically identify the best performing combinations, and the best performing combinations would receive more and more budget. In one example, at the end of the campaign, the system could identify a small subset (e.g.,) three out of the combinations that performed exceptionally well, and continue to feed more budget into those combinations in a focused follow-up campaign to continue to get more users exposed to the coupon, more users grabbing it and more users using it.

Returning back to the example, mix as defined is dependent on what the goals of the campaign are going in. For example, suppose the goal is to drive maximum trial of a new product at the lowest, possible cost. Assume as before that a sequence of different coupon combinations is defined. In this example, suppose we identify initial target audiences and MOCA combinations, and then, launch the campaign with an even mix to see which ones perform better. Suppose, in this example, the highest value of the coupon is performing exceptionally well within a specific target segment. However, there are other target segments that are still redeeming even the lowest value of coupon. Since the goal in this campaign is to move a maximum number of trials at the lowest cost, the system would funnel the budget of the campaign over time towards the lowest value coupons, and the combinations of segments are still redeeming those coupons of lower value compared to the high value combinations.

In this example, the campaign objectives are such that the system over time would optimize to buy more of the media and the segments that are continuing to redeem the lower value coupon. However, since the goal is to move as many units as possible at the lowest cost, a mix may still be required due to the problem of inventory exhaustion. The objective is to buy the maximum inventory available for the lowest cost audience first. However, as that inventory becomes exhausted, the system is then forced to buy the next cheapest, lowest cost value until that inventory was completely exhausted. Only after those are exhausted, those inventories which are exhausted would the system go on to a third higher cost audience. Basically, in this example, the mix is defined by determining the lowest cost options and performing incremental exhaustion of inventory sources starting with the lowest cost inventory source first.

Now consider an example in which a marketer would have a different goal in using the optimization engine. In this instance, a marketer is looking to maximize trial for a specific audience segment. In this case, they already know what audience they want to target. The system will programmatically determine the best performing incentive combinations for this given audience.

Consider another example where the system is used to define an ideal coupon for conventional FSI distribution, such as in a local newspaper. In this example, a marketer wants to serve out a coupon through an existing newspaper, FSI type channel such as newspapers in the Dallas Fort Worth area. FSI coupons are extremely expensive, have very long lead times, (sometimes six-eight months from planning to publishing) and are extremely expensive, typically in the multi-million dollar campaign range.

In this example, the system of the present invention can be used to pre-test the best combination of offer value, messaging, and creative for the FSI type channel, which in this case are newspapers in the Dallas Fort Worth market. In this example, the campaign is structured to test different combinations of coupon face value and different combinations of coupon creative and messaging. The system then show these coupons through existing channels, targeted in this instance to the geographic region of Dallas Fort Worth. The system then determines which combinations deliver the best results. The findings from this system output can then be used to define the ideal coupon for that market. In this particular instance, we may find that the $2.00 coupon with the creative that shows a happy family with their child performs best in the Dallas-Fort Worth area. This ideal coupon combination for the Dallas-Fort Worth area can then be applied to the manufacturer's future FSI campaign, and in the process, deliver much higher results and returns for that very expensive FSI campaign.

Now consider an example where a marketer is unsure which audience segments will be the best targets for their campaign. In this example, the system can help to prospect for new audience segments. In this example, the same creative, messaging, and the same offer value is used for all audiences. A variety of audience segments are selected (e.g., a dozen audience segment to target). These can be based on any of the typical existing audience parameters. It could be anything from male/female gender, age ranges, 8 through 24, 25 through 34, etc.

In this example of prospecting for new audience segments, the system shows the same creative and offer value unit to all 12 audiences. The system can then see which audiences saw that unit, which ones grabbed it with the intent to use it and which ones actually used it, and redeemed it at a retailer. The system can then optimize the mix based on audience segment, reallocating the mix to those audience segments that work best. So, in this instance, it would allocate the budget to these segments that showed the greatest redemption of the coupons and moved budget away from the ones that showed least redemption.

The system would repeat this over the length of the campaign on that same weekly interval and would reallocate to spend as it moves through in order to identify which one of these segments are the best segments for the campaign to target.

Discovering the best performing audience segments can then be used by the advertiser for future coupon campaigns. Additionally, it can also be used for product development insights, and also for general use in any advertising campaign that they are running.

Consider another example where again a marketer is unsure which audience segments will be the best target for the campaign, they want a prospect for new segments. In this case, the system will collect data to generate audience data and identify audience segments within the audience data. In this example, the campaign would run on Real Time Biddable (RTB) inventory sources in the advertising exchanges. The same create and offer value would be used across all audiences. Initially, the campaign would be a wide open campaign on the RTB media sources (e.g. very little or no audience targeting).

The system receives feedback on whether the incentive is viewed, delivered, and redeemed. After a period of time (e.g. one week), the system would collect a large collection of unique user IDs along with whether or not they saw, grabbed or redeemed the incentive unit. The system is then able to process audience verification. The system will take the unique IDs and match them up against third party data sources, which can be data vendors such as DataLogix Lotame, or Exelate.

Using this data, the system can then layer on this audience information on to the unique IDs of individuals that have already run through the campaign. This allows the generation of new audience segments out of this information. For example, suppose there are 1,000 unique IDs who came through the system who saw, grabbed and used the coupon. The audience verification process will segregate these unique IDs into audience parameters. For example, for a diaper campaign, the unique IDs might show an audience segment for new mothers in the midwest. Alternatively, the data may reveal or emerge a segment for existing mothers. Identifying promising market segments is also very useful information to apply to product development and branding vehicles.

Now consider an example in which a marketer has used the system to run incentive campaigns for several years for an existing product line (example—traditional diapers) and now wants to introduce a related, but entirely new product extension (example—biodegradable diapers). Over the previous years, the system will have generated a large amount of highly relevant data on incentive combination performance against audiences. This data may reveal valuable cross-category correlations that may be applied to the new product's development, external marketing, and incentive campaigns.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

What is claimed is:

1. A method for targeting, pricing, construction, distribution, tracking, and optimization of incentives that are redeemable at a time subsequent to delivery, comprising:
generating incentive options for a marketing campaign of a particular product or service, the incentive options for an incentive unit including message options, offer value options, creative options, and audience segment options; and
distributing, via the digital communication channels, a mix of incentives during the marketing campaign, wherein an individual incentive has a unique combination of message option, offer value option, creative option, and audience segment and wherein an individual incentive is redeemable by an end user after delivery within a time period defined by the marketing campaign.

2. The method of claim 1, further comprising dynamically optimizing the mix of incentives during the marketing campaign based at least on delivery data indicative of when an incentive is delivered to a consumer for future redemption.

3. The method of claim 2, further comprising:
tracking delivery of each incentive;
tracking redemption of each incentive; and
optimizing the mix of dynamic incentives based on tracked delivery data and any available redemption data.

4. The method of claim 3, wherein the optimizing includes determining the performance of each incentive and adjusting the mix of incentives.

5. The method of claim 1, wherein the incentive comprises at least one of a printable coupon or a code for direct to card incentive.

6. The method of claim 1, wherein the range of offer values depends at least in part on the audience segment.

7. The method of claim 1 wherein an audience segment is based at least in part on demographic data and range of incentive values is scaled based at least in part on the demographic data.

8. The method of claim 1, wherein the range of incentive values is scaled based on individual user actions or behavior.

9. The method of claim 1, wherein the range of incentive values is scaled based on available inventory of the particular product or service.

10. The method of claim 1, wherein the range of incentive values is varied based at least in part on when an incentive is distributed.

11. The method of claim 1, wherein at least one of message options and creative options are based at least in part on the audience segment.

12. The method of claim 1, wherein performance of each unique combination of incentive value, creative format, text content, as well as its receiving audience, is tracked as a distinct digital entity.

13. A method for generating information for incentives that are redeemable at a time subsequent to delivery, comprising:
generating incentive options for a marketing campaign of a particular product or service, the incentive options including message options, offer value options, creative options, and audience segment options;
distributing, via the digital communication channels, a mix of incentives during the marketing campaign, wherein an individual incentive unit has a unique combination of message option, offer value option, creative option, and audience segment; and
determining performance of the incentives to determine a relationship between at least one parameter of the incentive options and receiving audiences.

14. The method of claim 13, where performance of each served incentive value is tracked against receiving audiences to determine relationships between incentive value and receiving audiences.

15. The method of claim 13, where performance of served creative format is tracked against receiving audiences to determine relationships between content format and receiving audiences.

16. The method of claim 13, where performance of served text content is tracked against receiving audiences to determine relationships between text content and receiving audiences.

17. A dynamic incentive system for incentives that are redeemable at a time subsequent to delivery, comprising:
a processor and a memory;
a user interface for a marketer to define a marketing campaign for an individual product or service, including at least creatives and message options;
a create module to create ad units having incentives, wherein the incentive is formed from message options, offer options, creative options, and audience segments;
a distribute module to distribute ad units, via the digital communication channels, containing the incentives for the individual product or service; and
an optimization module monitoring performance of the incentives during the marketing campaign and adjusting the mix of incentives for the individual product or service,
wherein an individual incentive is redeemable by an end user after delivery within a time period defined by the marketing campaign.

18. The dynamic incentive system of claim 17, wherein in a test mode the system distributed incentives to a general audience and determines audience segments from user ID information.

19. The system of claim 17, wherein the system optimizes performance of the incentives based on delivery data, where a delivery corresponds to a consumer receiving an incentive provided in an ad unit.

20. The system of claim 19, wherein the system further optimizes performance of incentives based at least in part on available redemption data.
